(19) United States
(12) Patent Application Publication
(10) Pub. No.: US 2010/0263243 A2
(43) Pub. Date: Oct. 21, 2010

(54) GREETING CARD WITH SLIDING PANEL ACTIVATION

(76) Inventor: Michael Sayre, Kansas City, MO (US)

Correspondence Address: SHOOK, HARDY & BACON LLP;INTELLECTUAL PROPERTY DEPARTMENT, 2555 GRAND BLVD, KANSAS CITY, MO, 64108-2613, UNITED STATES, 816-474-6550, 816-421-5547

(21) Appl. No.: 12/041,638

(22) Filed: Mar. 3, 2008

(51) Int. Cl. G09F 1/00

(52) U.S. Cl. 40/124.06

(57) ABSTRACT

A greeting card includes a body portion that defines an interior cavity. A sentiment panel is slidably received in the cavity via an opening in the body portion. The sentiment panel is movable from a concealed position, where a portion thereof is received in the interior cavity and obstructed from view by the body portion, to an extended position, where the portion is outside the body and is visible. Electrical components may be positioned inside the interior cavity and activated upon movement of the panel from the concealed position to the extended position.

### CROSS-REFERENCE TO RELATED APPLICATIONS

Not applicable.

### STATEMENT REGARDING FEDERALLY SPONSORED RESEARCH OR DEVELOPMENT

Not applicable.

### BRIEF SUMMARY OF THE INVENTION

The present invention relates to a greeting card. More particularly, this invention relates to a greeting card having a panel movable from a concealed position to an extended position.

The greeting card has a body which, in one embodiment, is formed from a card blank. The blank has a plurality of fold lines that define panels of the body. The panels define a space there between that is accessible via a slot. A sentiment panel is coupled with the body and slidably movable between a concealed position and an extended position. A recipient of the greeting card, upon reviewing the front of a front panel and any message thereon, pulls the sentiment panel out of the body to reveal any message and/or design thereon. Consequently, the front panel and the sentiment panel are viewable simultaneously.

Because the body of the greeting card defines a space therein, electrical components may be incorporated into the greeting card and concealed by the panels that define the body. The electrical components, which may include sound and/or lighting effects, may be activated by movement of the sentiment panel from the concealed to the extended position. In one embodiment, this is accomplished by placement of a contact switch in the space inside the body adjacent the sentiment panel. When the sentiment panel is in its concealed position, a portion of the sentiment panel is received between contact arms of the switch, thereby creating a break in the electrical circuit. As the sentiment panel is pulled out of the body, the sentiment panel is moved from between the contact arms, thereby permitting the contact arms to abut one another which, in turn, completes the circuit and activates the electrical components.

Further objects, features and advantages of the present invention over the prior art will become apparent from the detailed description of the drawings which follows, when considered with the attached figures.

### BRIEF DESCRIPTION OF THE SEVERAL VIEWS OF THE DRAWINGS

The features of the invention noted above are explained in more detail with reference to the embodiments illustrated in the attached drawing figures, in which like reference numerals denote like elements, in which FIGS. 1-5 illustrate one of several possible embodiments of the present invention, and in which:

FIG. 1 is a perspective view of a greeting card having a sliding panel constructed in accordance with an embodiment of the present invention and with sliding panel in a concealed position;

FIG. 2 is a perspective view of the greeting card of FIG. 1 with a front portion thereof separated from a rear panel to reveal the construction of the card;

FIG. 3 is front side elevational view of the greeting card of FIG. 1 with a portion of a front panel thereof cutaway to reveal an interior panel having slots therein and electrical components;

FIG. 4 is the same view of the greeting card of FIG. 3, but with the sliding panel moved to its extended position; and

FIG. 5 is an exploded, unfolded, perspective view of the greeting card of FIG. 1.

### DETAILED DESCRIPTION OF THE INVENTION

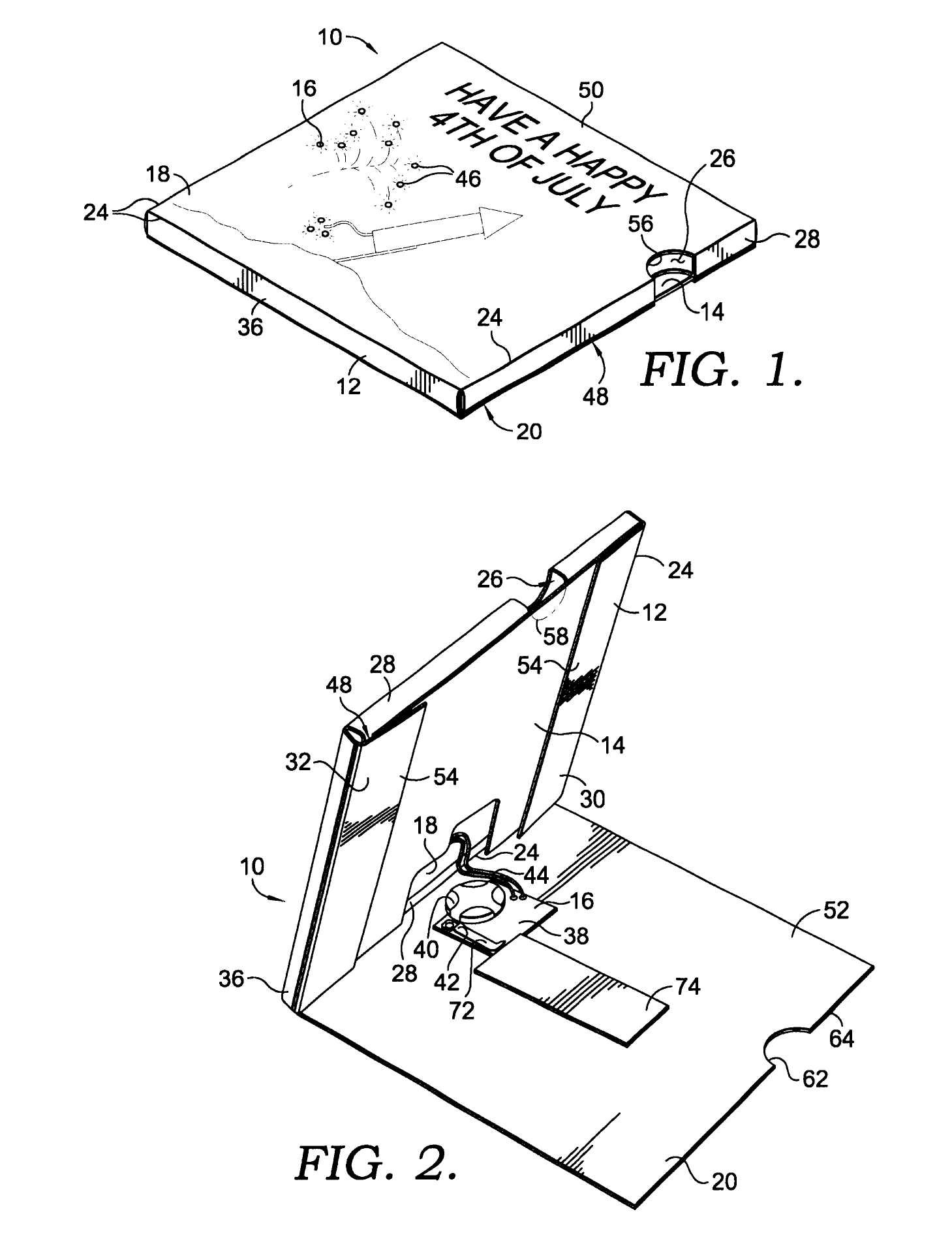

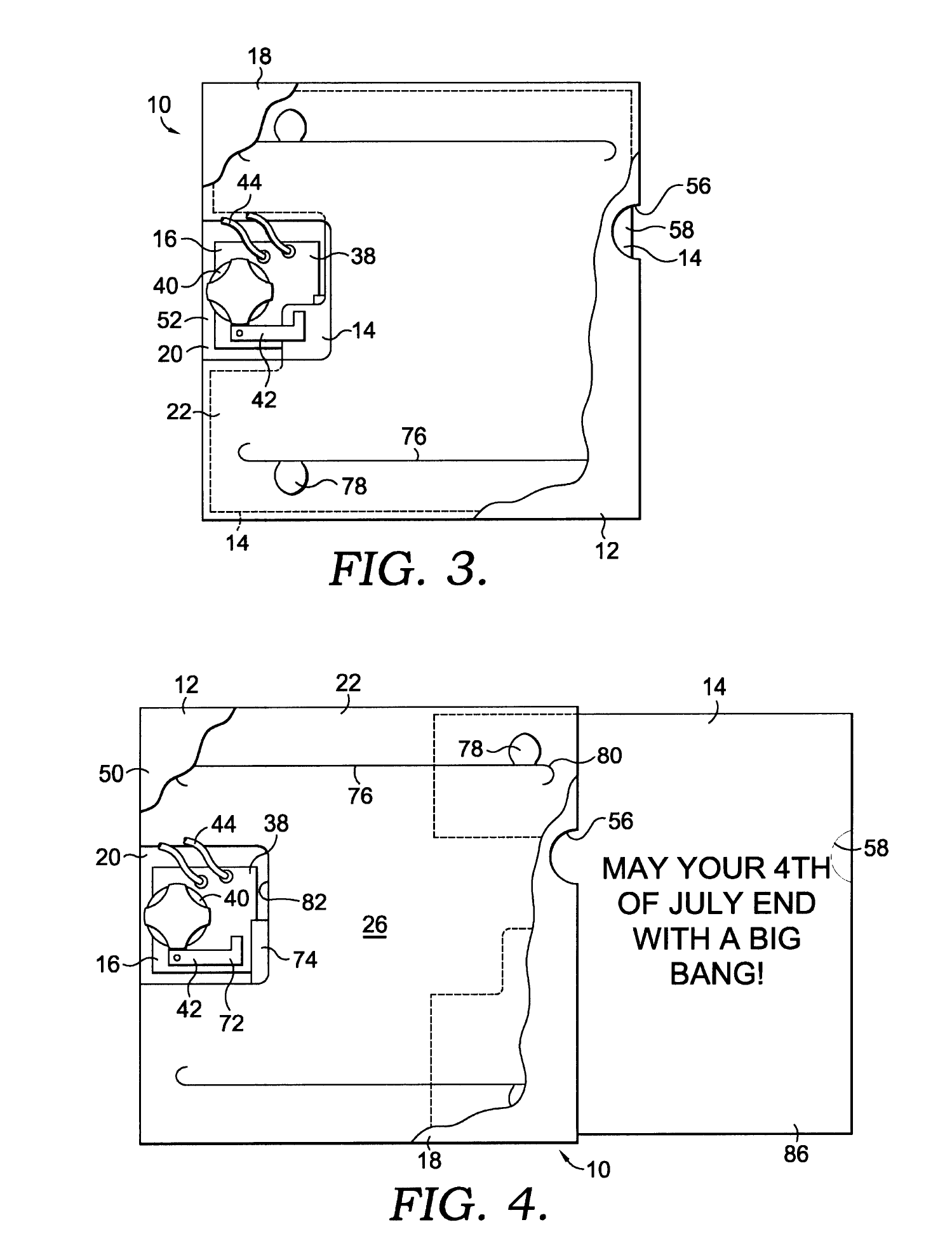

Referring now to the drawings in more detail and initially to FIG. 1, numeral 10 generally designates a greeting card constructed in accordance with the present invention. The greeting card 10 includes a body 12. A sentiment panel 14 is slidably received in the body 12 and is movable between a first or concealed position, illustrated in FIG. 1, and a second or extended position, illustrated in FIG. 4. Electrical components 16 may also be received in the body 12 and are preferably activated upon movement of the sentiment panel 14 from its concealed position to its extended position.

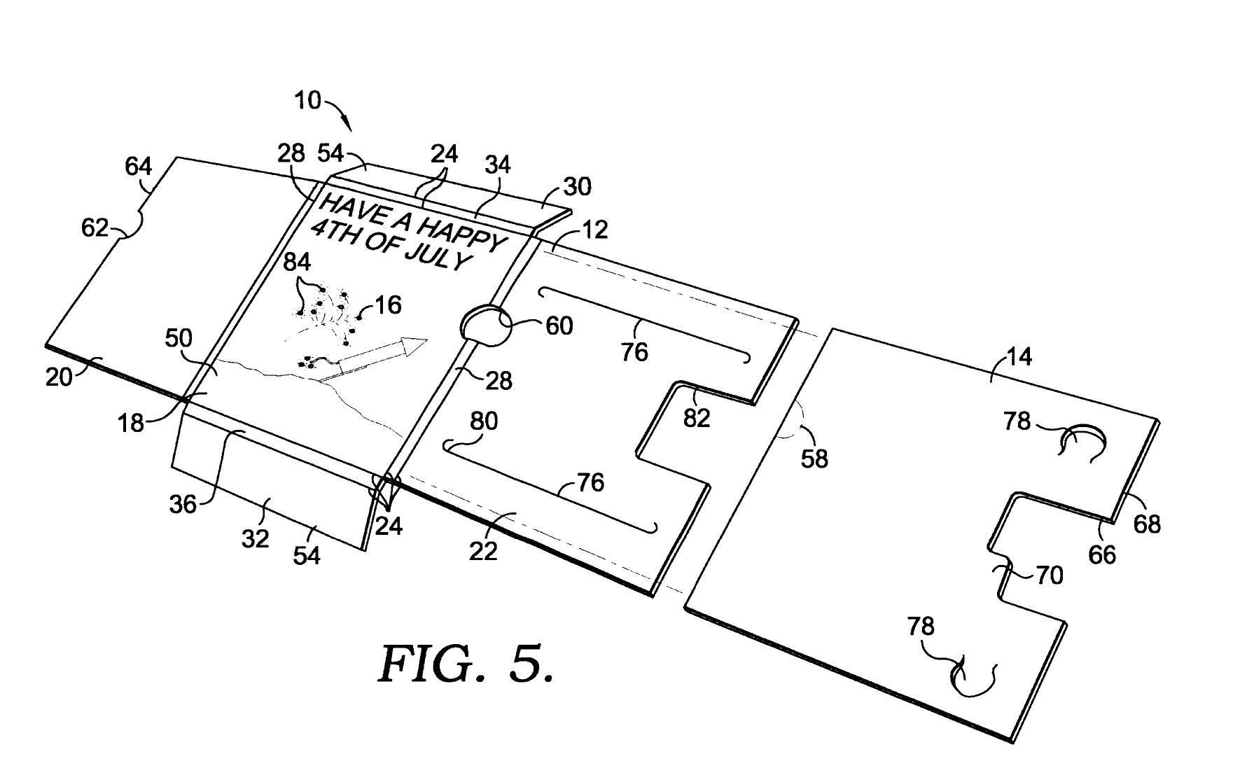

In the illustrated embodiment, the body 12 preferably has a front panel 18, a rear panel 20, and an interior panel 22. It should be noted that the greeting card 10 can be constructed without the interior panel 22; however, the interior panel 22 has been found beneficial in the illustrated embodiment, as will be discussed below. In the illustrated embodiment, the body 12 is formed from a single unitary card blank cut from thick paper or cardstock, as illustrated in FIG. 5. It should be readily understood that individual panels 18, 20, 22 may be provided and coupled with one another in any manner known in the art. The front, rear and interior panels 18, 20, 22 are preferably separated by and at least partially defined by one or more fold lines 24. By folding the card blank in various locations, the individual panels 18, 20, 22 are formed.

To provide the body 12 with a thickness and to define an interior cavity 26, panels 18, 20, 22 are separated by side panels 28 formed by a pair of closely spaced and parallel fold lines 24. To further complete the construction of the body 12, upper and lower flaps 30, 32 are provided. The flaps 30, 32 are positioned on opposite sides of the front panel 18. Again, to provide a thickness to the body 12 and to define the interior cavity 26, the flaps 30, 32 are preferably spaced apart from the front panel 18 by side panels formed by a pair of closely spaced and parallel fold lines 24. In this case, the side panels are an upper side panel 34 and a lower side panel 36.

As illustrated in FIG. 5, the rear panel 20 and the interior panel 22 are on opposite sides of the front panel 18 when the card blank is in its unfolded state. With the rear and interior panels 20, 22 and the upper and lower flaps 30, 32 being spaced apart from the front panel 18 by side panels 28, 34, 36, the card blank forms a box-like body 12 when it is folded from its flat state illustrated in FIG. 5 through its intermediate state illustrated in FIG. 2 and then, ultimately, to its final state illustrated in FIG. 1. As can be seen in FIG. 1, the side panels 28, 34, 36 provide the body 12 with a three dimensional thickness and space the front panel 18 away from the rear panel 20 in a generally parallel orientation to define the interior cavity 26. The side panels 28, 34, 36 are generally folded such that they are at a perpendicular orientation with respect to the front panel 18. Similarly, they are also at a generally perpendicular orientation with respect to the rear and interior panels 20, 22 as a result of the double fold lines 24 that create the side panels 28, 34 and 36.

Because of the construction of the body 12, the interior cavity 26 is formed, thereby presenting a space inside the body 12 into which items, such as electrical components 16 and the sentiment panel 14 may be received and obstructed from view by a user. For example, the greeting card 10 may contain electrical components 16 that include a circuit board 38 having a battery 40 and a switch 42 thereon for selectively powering the electrical components 16 of the greeting card 10. In the illustrated embodiment, a plurality of wires 44 lead from the circuit board 38 to lights 46 that may be selectively activated by the user of the greeting card 10. Additionally, the lights 46 may be controlled (i.e., turned on and off in a predetermined pattern or play sequence) by a program stored on the circuit board 38. While the lights 46 can be of any type known to those of ordinary skill in the art, the lights 46 in the illustrated embodiment are LEDs. Further, while the illustrated embodiment only depicts lights 46 as the electrical items that may be activated, other electrical items are within the scope of the present invention. For example, the circuit board 38 may be provided with a sound module (not shown) that stores and plays audible songs and/or messages upon activation of the greeting card 10 either alone or in combination with the lights 46. The sound module would include at least a memory and a speaker.

In addition to the electrical components 16 that are received in the interior cavity 26 of the body 12, the sentiment panel 14 is preferably selectively received in the interior cavity 26 in a first concealed position illustrated in FIG. 1 through an opening or slot 48. The slot 48 is created by a space being left between the rear panel 20 and the interior panel 22 once folded. As best illustrated in FIG. 2, the interior panel 22 is preferably folded back behind the front panel 18 until it is in a generally parallel orientation therewith. Subsequently, the upper and lower flaps 30, 32 are folded backwardly from an upper surface 50 of the front panel 18 and around the interior panel 22. At this point, the greeting card 10 looks essentially like what is illustrated in FIG. 2. The rear panel 22 is then folded backwardly around from the front panel 18 and then upwardly, as illustrated in FIG. 2, until portions of an inner surface 52 of the rear panel 20 abut lower faces 54 of the flaps 30, 32. Adhesive (not shown) may be placed on the lower faces 54 of the flaps 30, 32 to secure the flaps 30, 32 to the rear panel 20, thereby retaining the folded card blank in its folded position to create the body 12.

To provide the recipient of the greeting card 10 with the ability to easily withdraw the sentiment panel 14 from the interior cavity 26 of the body 12, the body 12 is provided with a cutout section 56 such that a user engageable portion 58 of the sentiment panel 14 is visible and accessible when the sentiment panel 14 is in its concealed position. The cutout section 56 allows a recipient of the greeting card 10 to pinch the user engageable portion 58 of the sentiment panel 14 between their thumb and a finger to pull the sentiment panel 14 out of the body 12. The cutout section 56 may be created by a oblong opening 60 through the card blank and a semicircular cutout 62 along an edge 64 of the rear panel 20. The oblong opening 60 through the card blank has a portion in the front panel 18, a portion in the interior panel 22, and a portion in a side panel 28.

To tie movement of the sentiment panel 14 with activation of the electrical components 16, the sentiment panel 14 can be made a part of the activation process of the electrical components 16. In the illustrated embodiment, this is accomplished by having a portion of the sentiment panel 14 cooperate with the switch 42. In that regard, a notch 66 is provided in a rear edge 68 of the sentiment panel 14. The notch is sized to go around the electrical components 16 when the sentiment panel 14 is fully received in the body 12. The notch 66 includes a wing 70 that is receivable between electrical contacts or contact arms 72 of the switch 42. When the wing 70 of the sentiment panel is intermediate the contact arms 72 of the switch 42, the electrical circuit is broken and the electrical components 16 are inactive. However, when the recipient or user of the greeting card 10 pulls the sentiment panel 14 out of the body 12, the wing 70 is removed from between the contact arms 72, thereby permitting the contact arms 72 to abut and complete the circuit, thereby activating the electrical components 16.

As illustrated in FIG. 2, the electrical components 16 maybe secured to the inner surface 52 of the rear panel 20. The notch 66 in the sentiment panel 14 lets the sentiment panel 14 be fully received in the body 12 and surround the electrical components 16 so as not to interfere therewith. A ramp or spacer 74 may be secured to the inner surface 52 of the rear panel 20 as well to align the wing 70 of the sentiment panel 14 with the contact arms 72 of the switch 42. This helps to prevent the sentiment panel 14 from accidentally going underneath the circuit board 38.

To prevent the sentiment panel 14 from being accidentally completely removed from cooperation with the body 12, a panel retention means is provided. In the illustrated embodiment, the retention means includes a pair of slits 76 through the interior panel 22 and a pair of ears 78 cut into the sentiment panel 14. When the greeting card is assembled, the ears 78 of the sentiment panel 14 are placed through the slits 76 in the interior panel 22. As the user pulls the sentiment panel 14 out of the body 12, the ears 78 will ultimately encounter ends 80 of the slits 76, thereby deterring further withdrawal of the sentiment panel 14 from the body 12. The interior panel 22 is also provided with a notch 82 so that it surrounds the circuit board 38 and other electrical components 16.

In use, a recipient of the greeting card 10 receives the greeting card 10 in the state illustrated in FIG. 1 where the sentiment card 14 is concealed and fully received in the body 12. Upon reading any message on the upper surface 50 of the front panel 18, the recipient pinches the user engageable portion 58 of the sentiment panel 14 and pulls the sentiment panel 14 out of the interior cavity 26 of the body 12. At some point during the withdrawal of the sentiment panel 14 from the body 12, the wing 70 of the sentiment panel 14 will become removed from between the contact arms 72 of the switch 42. At that point, the contact arms 72 will abut one another and complete the electrical circuit, thereby activating the electrical components 16 such as sound and/or the lights 46. The lights 46 are visible through holes 84 in the front panel 18. The electrical components 16 may continue to be activated for a predetermined time or until the sentiment panel 14 is pushed back into the body 14 to its concealed position where the wing 70 separates the contact arms 72 and breaks the electrical circuit.

From the foregoing it will be seen that this invention is one well adapted to attain all ends and objects hereinabove set forth together with the other advantages which are obvious and which are inherent to the method and apparatus. For example, the arrangement of the present invention provides a greeting card where a sentiment on the upper surface 50 of the front panel 18 and a sentiment on an upper surface 86 of the sentiment panel 14 may both be viewable simultaneously. Further, accidental activation of the electrical components 16 during handling or mailing, which can be found in prior art greeting cards with electrical components that are activated by a press switch, is eliminated.

It will be understood that various modifications can be made and still stay within the scope of the invention. For example, the electrical components 16, and particularly the circuit board 38, can be positioned in a different location in the interior cavity 26. Similarly, the method of retaining the sentiment panel 14 in cooperation with the body 12 can be modified and/or eliminated. It will also be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

What is claimed is:

1. A greeting card comprising:
a body having an interior cavity and an opening providing access to the interior cavity;
a panel received in the opening and movable between a first position, where a portion of the panel is received in the interior cavity, and a second position where the portion of the panel is positioned outside the interior cavity; and
electrical components positioned inside the interior cavity, wherein the electrical components include a battery and a switch and wherein the panel selectively cooperates with the switch, whereby movement of the panel from the first position to the second position changes the state of the switch, thereby activating the electrical components.

2. The greeting card of claim 1, wherein the switch includes contact arms, wherein a portion of the panel is intermediate the contact arms when the panel is in its first position, and wherein the panel is not intermediate the contact arms when the panel is in the second position.

3. The greeting card of claim 2, wherein the body has an upper surface, wherein the panel has an upper surface, and wherein both the upper surface of the body and at least a portion of the upper surface of the panel are visible simultaneously when the panel is in the second position.

4. The greeting card of claim 3, wherein the body is formed of a unitary card blank folded to define the interior cavity.

5. The greeting card of claim 1, wherein the electrical components further include at least one of lights and a sound module.

6. The greeting card of claim 1, wherein the body is formed of a unitary card blank, wherein the blank is selected from the group consisting of card stock and paper, wherein the blank has a plurality of fold lines, wherein the fold lines define separate panels, and wherein some of the panels define the interior cavity when the blank is folded.

7. A greeting card comprising:
a body having a front panel and a rear panel, wherein the front and rear panels are spaced apart from one another and are generally parallel to each other;
a movable panel selectively positioned between the front and rear panels, wherein the movable panel includes indicia on an upper surface thereof, wherein the movable panel is movable between a first position where the indicia is concealed from view by the front panel and a second position where the indicia is not concealed from view by the front panel;
a battery positioned between the front and rear panels; and
a switch electrically coupled with the battery and activated by movement of the movable panel from the first position to the second position.

8. The greeting card of claim 7, further comprising one or more lights electrically coupled with the switch, wherein activation of the switch activates the lights.

9. The greeting card of claim 8, wherein the one or more lights are turned on and off in accordance with a pre-programmed play sequence and wherein activation of the lights includes activation of the play sequence.

10. The greeting card of claim 9, further comprising a speaker electrically coupled with the switch and an audio message stored in the card, wherein activation of the switch initiates playback of the audio message which is heard via the speaker.

11. The greeting card of claim 7, further comprising a speaker electrically coupled with the switch and an audio message stored in the card, wherein activation of the switch initiates playback of the audio message which is heard via the speaker.

12. The greeting card of claim 7, wherein the switch includes a pair of electrical contacts, wherein the movable panel prevents activation of the switch in its first position, and wherein the moveable panel permits activation of the switch in its second position.

13. The greeting card of claim 12, wherein one of the electrical contacts takes the form of a contact arm biased toward the other electrical contact, wherein a first portion of the movable panel is intermediate the contacts when the movable panel is in its first position, and wherein the first portion of the movable panel is not intermediate the contacts when the movable panel is in its second position.

14. A greeting card comprising:
a body formed of a single, unitary card blank, the body having a front panel and a rear panel, wherein the front and rear panels are separated by one or more fold lines;
a movable panel coupled with the body and movable with respect thereto between a first position and a second position; and
electrical components received in the body, wherein the electrical components include a switch and wherein movement of the movable panel from its first position to its second position activates the switch, thereby activating the electrical components.

15. The greeting card of claim 14, wherein the front and rear panels are separated by a pair of fold lines, wherein the pair of fold lines define a side panel, wherein the front and rear panels are generally parallel to each other when the card blank is folded to form the body and wherein the front and rear panels are space apart by the side panel.

16. The greeting card of claim 14, wherein the body further has an intermediate panel separated from the front panel by one or more fold lines, wherein the intermediate panel is positioned between the front and rear panels when the card blank is folded to form the body, and wherein the movable panel is slidably coupled with the intermediate panel.

17. The greeting card of claim 16, wherein the intermediate panel includes a pair of slits therein, wherein the movable panel has a pair of ears cut therein, and wherein the movable panel is coupled with the body by the ears being received in the slits of the intermediate panel.

18. The greeting card of claim 14, wherein the body further has side panels, wherein the front and rear panels are generally parallel to each other when the card blank is folded to form the body, wherein the front and rear panels are spaced apart from each other by the side panels when the card blank is folded to form the body, wherein the front, rear and side panels cooperate to define an interior cavity, wherein the movable panel is received in the interior cavity when it is in its first position, and wherein the electrical components are received in the interior cavity.

19. The greeting card of claim 14, wherein the switch has a pair of electrical contacts, wherein one of the electrical contacts takes the form of a contact arm biased toward the other electrical contact, wherein a portion of the movable panel is positioned intermediate the contacts when the panel is in its first position, and wherein the portion of the movable panel is not intermediate the first and second contact arms when the panel is in its second position.

20. The greeting card of claim 14, wherein the electrical components further include one or more of the following: a light, a battery and a speaker

21. A greeting card comprising:
a body having a first panel and a second panel, wherein the first and second panels are connected to each other and are generally parallel to each other, wherein portions of the first and second panels are spaced apart from each other to define an interior cavity between the first and second panels, wherein the first panel has an upper surface, wherein the body has an opening therein which provides access to the cavity;
a movable panel coupled with the body and at least partially received in the opening, wherein the movable panel is movable between a first position, where a portion of the movable panel is received in the interior cavity, and a second position where the portion of the movable panel is positioned outside the interior cavity, wherein the portion of the movable panel has an upper surface that is obstructed from view by the first panel when the movable panel is in its first position, and wherein the upper surface of the portion of the movable panel is not obstructed from view by the first panel when the movable panel is in its second position, and wherein the movable panel remains coupled with the body during movement between and in its first and second positions to prevent accidental complete removal of the movable panel from receipt in the opening; and
electrical components positioned inside the interior cavity, wherein the electrical components include a battery and a switch, and wherein the movable panel selectively cooperates with the switch, whereby movement of the panel from the first position to the second position changes the state of the switch, thereby activating the electrical components.

22. The greeting card of claim 21, wherein the first panel is connected to the second panel by one or more fold lines, wherein the movable panel is generally parallel to the first and second panels, wherein the portion of the movable panel slides in and out from between the first and second panels when the movable panel is moved back and forth between its first and second positions, wherein the electrical components further include a speaker electrically coupled with the switch and an audio message stored in the greeting card, wherein activation of the switch initiates playback of the audio message which is heard via the speaker.

23. A greeting card comprising:
a first panel having an upper surface with a first cutout section along one edge;
a second panel connected to the first panel and generally parallel thereto, wherein portions of the first and second panels are spaced apart from each other to define a cavity between the first and second panels, wherein the first and second panels cooperate to define a card body, wherein the body has an opening therein which provides access to the cavity, wherein the second panel has a second cutout section along one edge, wherein the second cutout of the second panel is aligned with the first cutout of the first panel to define a cutout section for the body;
a movable panel coupled with the body, wherein the movable panel is generally parallel to the first and second panels, wherein a first portion of the panel is received in the cavity and is intermediate the first and second panels, wherein the movable panel is movable between a first position, where a second portion of the movable panel is received in the cavity, and a second position, where the second portion of the movable panel is positioned outside the cavity, wherein the second portion of the movable panel has an upper surface that is obstructed from view by the first panel when the movable panel is in its first position, wherein the upper surface of the second portion of the movable panel is not obstructed from view by the first panel when the movable panel is in its second position, wherein a third portion of the movable panel is positioned in the cutout section of the body when the movable panel is in the first position, wherein the movable panel remains coupled with the body during movement between and in its first and second positions to prevent accidental complete removal of the first portion of the movable panel from receipt in the cavity, wherein the movable panel slides between its first and second positions; and
electrical components positioned inside the cavity, wherein the electrical components include a battery, a switch, a speaker electrically coupled with the switch, and an audio message stored in the greeting card, wherein the movable panel controls activation of the switch, wherein activation of the switch initiates playback of the audio message which is heard via the speaker, whereby movement of the panel from the first position to the second position changes the state of the switch, thereby activating the switch.

24. The greeting card of claim 23, wherein the first panel is connected to the second panel by one or more fold lines.
